(19) United States
(12) Patent Application Publication
(10) Pub. No.: US 2009/0064576 A1
(43) Pub. Date: Mar. 12, 2009

(54) Potted plant watering system

(76) Inventor: Steven Lee Sugarek Sugarek, Houston, TX (US)

Correspondence Address: Roy Patrick Norris & Associates, P.C., 216 N. Michigan Avenue, League City, TX, 77573, US

(21) Appl. No.: 12/283,089

(22) Filed: Sep. 9, 2008

Related U.S. Application Data
(60) Provisional application No. 60/993,108, filed on Sep. 10, 2007.

(51) Int. Cl. A01G 27/04

(52) U.S. Cl. 47/81

(57) ABSTRACT

A potted plant watering system that uses the capillary action of a wick to draw water up from a water reservoir and into the soil of a potted plant via a plurality of fingers of a wick support member that secure the wick in predetermined patterns and maximizes soil contact during wet and dry conditions and distributes water evenly throughout the plant pot. A water flow control device attaches to the wick support member and by separating the wick's strands from contact with the water, controls the flow of water through the wick. A float mechanism provides for a reservoir level indication with minimum rise and arc of the float rod above the surface of the water reservoir and therefore minimizes risk of rod damage and observer confusion. The wick, flow control, and water level indication systems can be used with any existing plant pot equipped with a drainage hole.

### CROSS-REFERENCE TO RELATED APPLICATIONS

This application claims the benefit of provisional patent application Ser. No. 60/993,108 filed 2007 Sep. 10 by the present inventor, which is incorporated by reference.

### FEDERALLY SPONSORED RESEARCH

Not applicable.

### SEQUENCE LISTING OR PROGRAM

Not applicable.

### BACKGROUND

1. Field of the Invention

This invention relates to potted plant watering systems, specifically to an improved fluid distribution, flow control, and fluid level monitoring system for potted plants.

2. Prior Art

Stand alone potted plant watering systems tend to consist of a plant pot, wick, and a fluid reservoir. One end of a capillary wick is immersed into a reservoir containing a fluid, such as water, and the other end is imbedded into the soil of the potted plant. The capillary action of the wick draws the water from the reservoir up into the soil. However, current potted plant watering systems tend to have significant drawbacks in at least three areas: maintaining capillary wick contact with the soil, ease and ability of controlling the amount of water that is released to the soil, and simplicity in monitoring the levels of remaining water in an associated reservoir.

Current capillary wick systems tend to consist of three main designs, bottom laying, freeform, and vertically positioned, that through use and testing, tend to prove both ineffective in adequately maintaining effective contact between the wick and the soil and ineffective in transmission of moisture evenly throughout the plant soil. The lack of contact between the wick and the soil means that water is not being transferred to the soil. Lack of contact can occur when the potted plant soil becomes dry and the soil contracts and separates from the wick, or because the wick was ineffectively installed in the soil by the potted plant owner such that a wick is not evenly distributed throughout the soil. Wick designs such as depicted in U.S. Pat. Nos. 4,420,904 or 4,527,354 or 6,418,446, are the bottom lay and freeform designs. Merely having the wick lay flay in the bottom half of a potted plant ensures separation of the soil from the wick as the soil dries and contracts. This is the same problem with free-form, unsupported wicks. The potted plant owner is expected to carefully layer soil and wick, and this rarely occurs, and over time the wick, unsupported, works its way back to lay at the bottom of the pot; pulled down to the bottom by the weight of the water it is carrying to the surrounding soil and through the drying and contracting cycles of the pot soil. When soil in a potted plant begins drying from lack of moisture or from heat due to exposure to direct sun, the soil begins to pull away from the sides and bottom of the surrounding plant pot and ultimately from any wick contained therein. This leads to surprise problems when the owner attempts to refill his or her water reservoir and then wonders why the capillary action is not working. The only solution for freeform and bottom laying wicks is to press the soil firmly back into the bottom of the pot and therein damaging the delicate root structure; especially of fragile root systems such as orchids. Another problem with these wick designs is the lack of surface contact available to transmit moisture between the wick and the soil throughout the plant pot regardless of contact with the soil. The lack of surface contact translates into only a minimum amount of water being effectively transferred from the water reservoir into the potted plant soil and this is especially a critical factor in dry climates or situations where the potted plant is in full sun. The same contraction effect occurs on wick systems such as those depicted in U.S. Pat. No. 4,389,815; namely, wicks that are vertically positioned within a potted plant and remain vertical. Again, testing has shown that when the soil dries, the soil contracts completely from any vertical wick structure that has been implanted within a pot. On vertical wick designs, the force of gravity and vibrations from tamping the sides and bottom of the plant pot do not restore contact between the soil and the wick structure. Testing has also shown that flat, freeform, and vertical wick structures are especially ineffective in transferring fluid at a rate fast enough to compensate for soil evaporation in dry climates because too little surface area of the wick is exposed to the soil and an insufficient amount of the wick is evenly distributed throughout the soil. Since the wick is incapable of being consistently and evenly distributed throughout the soil, then the water is distributed only to a particular area of the potted plant soil and is not distributed uniformly through the potted plant. Freeform wicks, such as those similar to U.S. Pat. No. 6,418,664 noted earlier, are also ineffective in evenly distributing water throughout the soil. Freeform wicks do not have adequate contact with the soil because the exposure to the soil is only through the outer surface of the wick itself. Therefore, there is too little surface area to transfer and evenly distribute water into the potted plant. Further, since the potted plant owners themselves are required to lay the free form wicks into the soil, human error further guarantees that the wicks will not be evenly distributed to transfer water to the soil in a consistent manner. Over time, the freeform wicks will settle to the bottom of the plant pot, as noted earlier, and will further ensure the lack of evenly distributed water to the potted plant.

Plant pot watering systems that have capillary wicks can also have flow controls to lessen the capillary action. Reducing the capillary action is useful for reducing the soil's moisture content for dry-loving soil plants such as African Violets or different breeds of cacti. The water still flows from the water reservoirs to the soil of the potted plants, but the flow controls can reduce the rate of flow and thereby reducing the overall moisture content of the soil. The current flow controls for potted plants consist of applied or restrictive pressure controls such as depicted in U.S. Pat. No. 4,999,947 or are controlled by merely reducing or increasing the number of total wick number within the potted plant system. Pressure flow controls use friction, screw, or twisting mechanisms to squeeze the wick and reduce the ability of the wick to draw water through it. All of these involve overly complex mechanical systems that are prone to breakdown and premature aging and failure; especially in full sun climates. Systems which control water flow by the number of wicks require the owner to totally repot a potted plant if the owner wishes to increase or decrease the number of wicks within the plant watering system. Other flow control devices require extensive manipulation of wicks and any attempt to insert additional wicks into an already potted plant or any attempt to pull wicks out of an already potted plant further damages the fragile root structure. More often than not, the owners just resign themselves to either over watering or under watering a plant because they cannot easily control the flow of water. The readily observed effect is the loss interest in the art of horticulture as their violets stay bright and green but never bloom or their expensive investment of potted orchids die in too soupy pots.

Finally, owners are often beset with the problem of not knowing when their potted plant water reservoirs need refilling. This problem has been previously addressed through a variety of float mechanisms that may look different at first glance, but further study reveals that most are simple one to one ratio float mechanisms housed in uniquely customized plant pots or water reservoirs, such as depicted in U.S. Pat. Nos. 4,885,869 and 4,527,354 and 6,418,664. These simple one to one ratio float mechanisms consist of a lighter than water buoy attached to a long rod that, at a minimum, is as long as the water reservoir is tall. The rod is typically attached to the water reservoir or plant pot and rises and falls with the level of the water in a one to one ratio. If the water level rises one inch, then the mechanism also rises one inch above the pot or reservoir. If the water reservoir is full, then the rod attached to the float mechanism is fully extended above the level of the pot or water reservoir; if empty, the float rests on the bottom of the water reservoir and the float rod extends somewhat lower or is flush with the surface of the pot or water reservoir. The problem here is that testing has demonstrated that one to one ratio float mechanisms like these tend to break off or become damaged because when they are so extended above the water reservoir, then the extended member is prone to getting caught on a passing water hose, child's fingers, or dog chain and being broken off. Further, these types of float mechanisms are quite prone to becoming clogged and becoming stuck in position and therefore become useless in telling the user how much water remains in the reservoir. These simple float mechanisms, rising so far above the water reservoir, attract leaves, lawn clippings, and dirt and in full sun climates, become quickly impaired. Further, all of these mechanisms require specially manufactured plant pots or water reservoirs to house the float mechanism. This means that for current plant pot watering systems, the owners who desire to use their own plant pots, or their own plant pot water reservoirs, lose that opportunity if they desire to have a water measuring capability. The owners are forced to repot a delicately rooted plant from their own familiar pot into a new plant pot with a water level measuring system that is unwieldy and, ultimately, prone to failure. Finally, the simple single bend float mechanisms that utilize a fulcrum point near an indicating end with a float at the distal end fare no better. These mechanisms cut a high and deep radial arc above their indicating surface and not only do they suffer from risk as damage as their no-fulcrum counterparts, but they are confusing to read as the water level is measured both by distance above an indicating surface as well as the radial arc distance to the left or right of the indicating surface. Electric monitoring mechanisms are complex, prone to damage from cold and heat and require a source of power.

### SUMMARY

This Potted Plant Watering system is a watering device for potted plants comprising a capillary wick device with a plurality of fingers that secure the strands of a fibrous wick in predetermined patterns and maximizes soil contact during wet and dry conditions, and distributes water evenly up from a water reservoir to and throughout the plant pot. This system also comprises a water flow control device that easily and consistently controls the amount of water flowing through the wick and allows the owner to adjust the soil moisture appropriate for the potted plant's needs without changing or damaging the wick. Finally, this system contains a water level indicator that signals when the water reservoir is full or empty with a minimum rise, fall, and radial arc of the indicator above the surface of the water reservoir and therefore minimizes water level indicator damage and confusion in reading the water level.

### DRAWINGS—FIGURES

FIG. 1—A cross-sectional view of an assembled potted plant watering system.

FIG. 2—A perspective view, shown partly broken away, to show the component interconnectivity of the potted plant watering system.

### DRAWINGS—LIST OF REFERENCE NUMERALS

10—plant pot for use with potted plants
14—capillary action wick
16—wick support member
19—plant pot water drainage hole
20—plant pot support member
24—water reservoir
26—water supply
28—water flow control device
32—float rod
34—wick strands separated to not pass into water supply
40—upper portion inner lip of water reservoir
48—center opening of water flow control device
50—alert opening in plant pot support member for water level indicator
54—screen covered reservoir refill opening.
56—center opening of plant pot support member
58—water level indicator end of float rod
64—weight support member
68—fulcrum to pivotably attach float rod
70—lattice structure
80—screen covered water flow gaps within weight support members

### DETAILED DESCRIPTION

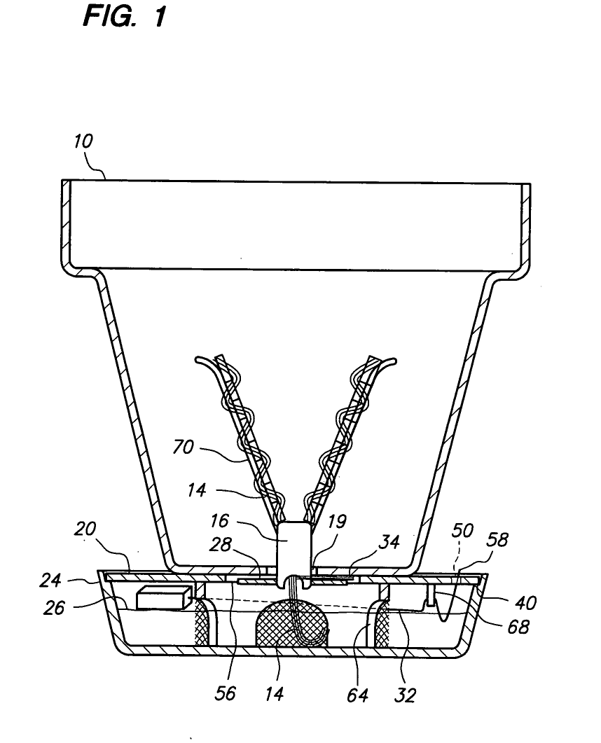

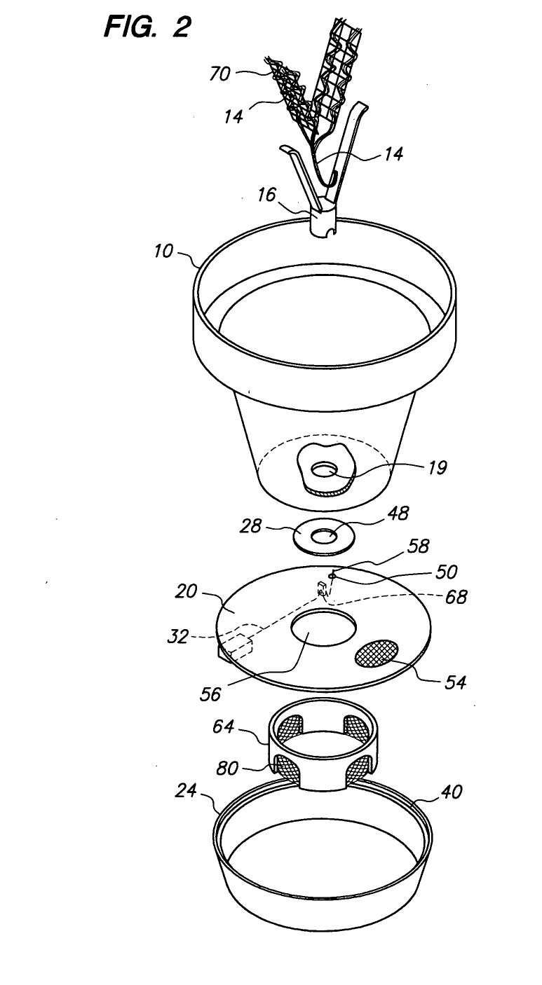

The first embodiment of the device is shown in FIG. 1, a side view, and FIG. 2, a perspective view. A standard plant pot 10, has located on its lower end a drainage hole 19. The standard plant pot 10 defines an interior volume that is used to house a supply of soil. Within this interior volume resides a wick support member 16 that has a lower end that terminates into a slightly grooved rigid base and an upper end that terminates into a plurality of rigidly flexible fingers adjustable to predetermined angles that each in turn terminate into an upwardly and outwardly flared tip. The base end of wick support member 16 resides within a void created by the drainage hole 19 and terminates at a point that extends slightly beyond the exterior bottom end of plant pot 10. Attached to the inner surface of each of the fingers of wick support member 16 is a rigidly flexible lattice structure 70. One end of a capillary action wick 14 is passed upwardly through the base end of wick support member 16 via an interior passageway, and once emerging through an upper portion of the base end of wick support member 16, this end of wick 14 is separated into a plurality of individual strands. The individual strands are attached across the surface of each lattice structure 70 from the lower end of the lattice to the upwardly terminating end. The other end of wick 14 emerges from the bottom exterior side of plant pot 10. From this end of wick 14 a predetermined subset of strands 34 is separated but not detached from the remainder of wick 14 and these strands do not pass through a center opening 48 of a water flow control device 28. However, the remainder of wick 14 does pass through the center opening 48 of the water flow control device 28. The water flow control device 28 is formed as a flat ring having a central opening sized to fit over and attach to the lower end of wick support member 16. The captured strands 34 pass through a groove cut into the terminating lower end of wick support member 16 and are securely held between the top surface of water flow control device 28 and the exterior bottom surface of plant pot 10. The remainder strands of wick 14 that do pass through the center opening 48 of the water flow control device 28 then pass on through a center opening 56 of a plant pot support member 20. The plant pot support member 20 rests securely upon an inner lip 40 located upon an upper portion of a water reservoir 24 and contains a screen covered refill opening 54. The diameter of center opening 56 of the plant pot support member 20 is larger than the outside diameter of the water flow control device 28. Therefore, when the plant pot 10, with the wick support member 16 and flow control device 28 installed therein, is set centrally upon the plant pot support member 20, there is no interference between the inner edge of center opening 56 and the outer edge of water flow control device 28. On the underside of plant pot support member 20 is located a fulcrum 68 to which a float rod 32 is pivotably attached. The float rod 32 is of a rigid material with a plurality of bends and has an indicating end 58 and a distal end to which a float member is attached. The indicating end penetrates through an alert opening 50 located on plant pot member 20. A weight support member 64 resides within the interior volume of water reservoir 24 and when installed does not interfere with the interconnectivity of the plant pot support member 20 to the water reservoir 24 nor does it interfere with the range of motion of the float rod 32. The weight support member 64 is of such height as to abut the bottom surface of plant pot support member 20 and the top surface of the bottom inter end of water reservoir 24. The weight support member 64 contains a plurality of mesh covered openings 80. Within the central volume of weight support member 64, the lower end of wick 14 that has passed through the water flow control device 28 and through the center opening 56 of plant pot support member 20 will rest. Within the interior volume of water reservoir 24 will be a water supply 26.

### Operation

Referring to FIGS. 1 and 2 for the first embodiment. Wick 14 is constructed of a material that has a capillary, or wicking, action capable of transferring moisture from the water reservoir 24 to the plant roots located in the surrounding soil contained within the interior volume of plant pot 10. As the soil dries and the wicking action occurs, water is pulled from the water reservoir 24 upwardly to and through the inner passageway at the lower base end of wick support member 16, and then after emerging from the upper base end of wick support member 16 is transmitted throughout strands of wick 14 attached to the lattice structure 70 located upon the plurality of fingers of wick support member 16. Without contact between the soil and the wick 14, the capillary action of drawing water up from water reservoir 24 to the soil of plant pot 10 cannot occur. The lattice structure 70 is adapted to increase and maximize the surface area of the wick strands of wick 14 exposed to the surrounding potted soil. The predetermined angles of the fingers of wick support member 16 further operate to maintain and maximize the contact of the wick strands with the soil. Because the length and angle of the fingers of wick support member 16 allow for even distribution of the water moisture throughout the soil, then if the soil dries more quickly than the wick 14 can transmit moisture, or if the water reservoir 24 is allowed to become empty, then the soil is prevented from contracting away from the plurality of fingers of wick support member 16 and critical contact with the strands of wick 14 is maintained. Operationally, the first embodiment uses a predetermined angle for the fingers of wick support member 16, as measured from vertical, that is between 20 degrees and 70 degrees for each finger of the wick support member 16 and a finger length that is approximately one third of the height of the averagely proportioned flower pot. A plant pot that is short in height but very wide in diameter would have fingers angled closer to 70 degrees whereas a plant pot that is tall in height but very narrow in diameter would have the fingers angled more closely to 20 degrees proportionately.

Controlling the rate of capillary action allows the user to control the moisture content of the soil in the plant pot 10. This is necessary as some plants, such as African Violets, require a much drier soil than does other plants such as orchids. Control of water movement is effected through the water flow control device 28. The users select a predetermined amount of strands that they do not wish to be in contact with the water supply 26; the higher number of wick strands that are in contact with the water, the more water is transmitted to the soil of plant pot 10 and the lower number of wick strands in contact with the water means that less water is transmitted. After wick 14 emerges from the bottom base end of wick support 16, selected strands from the fibrous wick 14 can be separated but not detached from the wick 14 and formed into the set of separated wick strands 34. Unlike the remaining wick 14 strands which then pass on into the water supply 26 located in the water reservoir 24, the separated wick strands 34 are secured behind the water flow control device 28, up against the bottom side surface of plant pot 10, guided by the groove at the bottom base end of wick support member 16. These wick strands 34 are now out of direct contact with the water contained in water reservoir 24. The effective diameter of wick 14 in contact with the water supply 26 is therefore lessened and therefore so is the ability of wick 14 to transfer moisture from the water supply 26 also becomes proportionately less.

At some point during the wicking process, the water reservoir 24 will need to be refilled as the water supply 26 will become exhausted and wicked away. This is accomplished by pouring water through the reservoir refill opening 54. The refill opening is covered with a fine mesh or screen to prevent the entry of any foreign debris into the water supply 26 contained within water reservoir 24. The water level indicator 58 visually indicates to the user when the water reservoir 24 is filled with water. When water reservoir 24 is “full” of water, the water level indicator 58 will be almost level with the topside surface of plant pot support member 20. When the plant pot reservoir 24 is “empty” of water, the water level indicator 58 will be just visible but will also be at its greatest extended height above the topside surface of plant pot support member 20. Graduated levels of water in water reservoir 24 therefore correspond to graduated levels of extension of the water level indicator 58 above the topside surface of plant pot support member 20. Therefore, the user can determine the remaining water level in water reservoir 24 by looking at the length of the water level indicator 58 that extends above plant pot support member 20. The water level indication is accomplished via the float rod 32 that is pivotably attached to a fulcrum 68 located on the bottom side of plant pot support member 20. The float rod 32 has a plurality of bends adapted to limit the height and width of the radial arc that is upwardly created by the motion of the water level indicator end 58 as it rises and falls above the plant pot support member 20. This is to minimize any potential damage to the indicator end 58 as it sits exposed above plant pot support member 20.

The plant pot support member 20 is adapted to support the weight of the plant pot 10, to support the the water level indicator 58, to provide a water refill capability through the refill opening 54, and when the plant pot support member 20 is placed upon the upper portion of water reservoir 24, the water reservoir 24 becomes sealed, and thereby resists the transmission therein of dirt, dust, and insects. The weight of plant pot 10 is further supported with a weight support member 64 that transmits the weight of the plant pot 10 from the bottom side of plant pot support member 20 to the top side of the bottom end of water reservoir 24. The weight support member 64 is centrally located within the water reservoir and its plurality of gaps 80 allow water to pass through from its outer volume into its inner volume. The gaps 80 of weight support member 64 are also covered with screen members thereby resisting foreign material to pass through the openings and impede the capillary action of the wick 14, but the screen members do not impede the transfer of water within the water reservoir 24. The screen members on gaps 80 also serve a critical purpose in preventing any roots contained within the plant pot 10 that have grown down from plant pot 10 through drainage hole 19 into the water reservoir 26 from impeding the function of the float rod 32.

### Alternative Embodiments

Referring to FIGS. 1 and 2, the following represent alternative embodiments.

(a) One alternative embodiment envisions the Potted Plant Watering system as described herein but the wick support member 16 exists without an attached lattice structure 70. The wick 14 still enters the base end of wick support member 16 and travels upwardly through the base but in this embodiment, the strands are gathered together and attached securely and directly to the rigidly flexible fingers of wick support member 16. As there is no lattice structure 70, then the owner's hand may pinch together the rigidly flexible fingers wick support member 16 to the point at which the flared tips touch. The user may now insert the flared tips upwardly into and through the drainage hole 19 located in the bottom of plant pot 10. By continually applying a slight pressure, the wick support member 16 gradually passes through the soil contained therein. The flared finger tips of wick support member 16 ensure that the fingers ultimately then spread back apart within the soil in a correctly installed position as they pass through the soil; the flared fingers acting as guided blades when passing through the soil. The user then merely adds the water flow control device 28, feeds the appropriate amount of wick 14 through and into the interior volume of water reservoir 24, and then rests the plant pot 10 upon the plant pot support member 20.

(b) Another alternative embodiment envisions the Potted Plant Watering system as described herein but there is no water reservoir 24. Instead, the owner uses their own plant pot and associated water reservoir 24. The plant pot support member 20 is sized to fit standard existing plant pot water reservoirs and is placed upon that plant pot water reservoir 24 interior lip 40 thereon or, if necessary, an appropriately sized weight support member is also used to support the plant pot 10 upon the user's own water reservoir.

(c) Another alternative embodiment is the Potted Plant Watering System as described herein but the plant pot support member 20 is not flatly formed as shown in the FIGS. 1 and 2, but rather has a slight concave surface as referenced from the installed configuration in the water reservoir 24. The purpose of this embodiment is to allow natural fallen rainwater to collect into the center opening 56 of the plant pot support member 20 and thus fall into the water reservoir 24 itself. If necessary, the plant pot 10 itself can be adapted to sit on the concave plant pot support member 20 in a slightly elevated fashion such that it does not seal out the water from flowing from the outer edges of the surface of plant pot support member 20 in and under the plant pot 10 to the water reservoir 24. The concave surface can be as a result of the manufacturing process or, can be the result of choosing a less rigid material such that the weight of the plant pot 10 deflects the surface of the plant pot support member 20. The weight support members 64 would be height adjusted to be lower accordingly to allow the appropriate concave surface or deflection to occur.

### Advantages

From the detailed description above, a number of advantages of some embodiments of the plant pot watering system become evident:

(a) One advantage of the embodiment is the ability to increase the amount of surface contact between the wick and the soil. The increase in surface contact with the soil increases the efficiency and ability of the wick to transfer water from the water reservoir up into the plant pot. Increasing the surface contact between the wick and soil also reduces the problem of shrinkage and contraction away from the wick if the user should let the water reservoir and plant pot completely dry out and then attempt to reactivate the wicking process. The wick is also exposed to the soil at an angle; instead of vertical or randomly laid within the pot, which greatly reduces the effect of the soil contracting away from the wick and greatly increases the transfer of water between the wick and the soil. The increase in contact between the wick and soil is also accomplished without having to resort to an extremely thick wick; rather, this embodiment can use a much thinner and cheaper wick, the strands of which are either attached to the wick support structure directly or attached onto a lattice, such that the surface area of the wick exposed to soil is greatly increased over the use of a more expensive single or dual thick wick. Further, this embodiment reduces the problem of evenly distributing moisture throughout the upper and lower levels and side to side regions of the plant pot. Verification has shown that this wick embodiment is far superior to any vertical, lay flat, or free form wick designs and far surpasses any other wick design in being able to transmit water evenly throughout the plant pot. This embodiment also reduces the difficulty for the user in consistently and correctly adding an effective wick system to the user's own existing plant pot.

(b) Another advantage of the embodiment is that the flow control device reduces the complexity of controlling water flow through the wick and reduces the problem of not being able to retrofit a wick control device onto an existing every-day plant pot. The flow control device also reduces the problem of the user in being able to effectively, simply, and cheaply control the flow of water through the wick. The flow control device also allows the user to consistently use the same wick in the plant pot regardless of plant pot usage; if an orchid is planted, then the user will only keep a few strands out of the water by the flow control device and most of the wick will descend into the water reservoir; if a violet, then many more strands will be kept out of the water and a far fewer portion of the wick will descend on into the water reservoir.

(c) Another advantage of the embodiment is that the configuration of the water level measuring device reduces the problem of breakage of the measuring stem and provides a simple, cost effective method of measuring the level of water within a water reservoir. The alternative embodiments reduce the problem of being able to simply and cheaply retrofit to the user's own existing plant pot a water level measuring device. The plurality of bends within the arm of the float rod ensures that only a minimum amount of the rod is exposed above the surface of the reservoir and the rod will move in a more horizontal motion as opposed to cutting a radial arc as the water level rises and falls within the water reservoir. This ensures the user will accurately read the water level indicated and will not confuse a mid-level water reading with an empty water reading.

(d) Another advantage is that the plant pot support member fits securely within the plant pot water reservoir and the plant pot itself is intended to fits securely on the plant pot support member and with the mesh or screen covering over the water refill hole in plant pot support member, the water in the reservoir is sealed in an enclosed reservoir and therefore prevents entry of insects and vermin.

(e) Another advantage is that the plant pot, wick, installed wick support member, and water flow control device, can be easily separated from the water reservoir by merely lifting the plant pot up from the plant pot support member. This allows for easy cleaning of the plant pot water reservoir without having to disassemble the wick or water flow control devices. The user can also easily trim away any excess roots that may have grown through the drainage hole into the plant pot reservoir.

(f) Another advantage is that the weight support member within the water reservoir has screens on the opening gaps to both prevent foreign debris from coating and disabling the wick as well as preventing any roots that have grown down into the reservoir from the plant pot from interfering with the actions of the water level indicator.

(g) An advantage of an alternative embodiment is that the plant pot support member has a concave shape that will catch fallen rainwater and direct the rainwater through the center opening and into the water reservoir saving the owner valuable time in watering the plant.

### Conclusions, Ramifications, and Scope

Although there are many automatic plant pot watering devices both on the market and within the prior art, there are none that can effectively work over the long term under severe outdoor environmental conditions of heat and wind. Moreover, there are none that can effectively work when the root structure of the potted plant has descended through the drainage hole and begins to interfere with the capillary action of the wick and interfere with whatever functionality exists within the water reservoir. The embodiments of the Potted Plant Watering System described herein ensure an effective and adjustable wick support system that will distribute water consistently throughout a plant pot; not just in the lower areas and one that will continue to distribute water even though the soil has begun to contract away from the sides of the pot. Further, the flow control device allows the user to adjust the wick amount in contact with the water for a variety of plant needs all using the same wick and all without disturbing the delicate root system of the potted plant. Finally, these embodiments have an accurate water level indicator without the danger of damage to the indicator and without confusion in reading exactly what the level of water is.

I claim:

1. A watering device for potted plants comprising:
(a) a wick formed from a plurality of strands of fibrous material that is water resistant, rot resistant, and capable of capillary action adapted to water from the lower end that is inserted into said water reservoir to the upper end inserted into an upper pot member containing a supply of potted soil.
(b) a wick support member comprising a plurality of fingers capable of holding said wick within the soil in predetermined patterns;
(c) a water flow control device capable of limiting the amount of water received through said wick;
(d) a reservoir adapted to hold said water supply;
(e) a water level indicator capable of measuring the depth of water within said water reservoir at all times;
(f) and wherein said wick is adapted to be inserted through said water flow control device and into said water reservoir such that a predetermined amount of water is capable of flowing through said wick.

2. The watering device of claim 1, wherein said water reservoir further comprises a plant pot support member on an upper portion adapted to support the supply of potted soil thereabove.

3. The watering device of claim 2, wherein said water reservoir comprises a weight support member adapted to support said plant pot support member and the weight thereon and includes a plurality openings adapted to allow water to pass through, and a corresponding plurality of screen members covering each opening and thereby resisting foreign material to pass through the openings, and wherein roots that have grown into the water reservoir from the plant pot are prevented from impeding with the function of the water level indicator, and wherein said lower end of said wick passes therein through the top of said weight support member.

4. The watering device of claim 2, wherein when said plant pot support member is placed upon said water reservoir and when the supply of potted soil placed upon said plant pot support member, the said water reservoir becomes sealed, and thereby resists the transmission therein of dirt, dust, and insects.

5. The watering device of claim 2, wherein said plant pot support member is formed with a slight concave top surface as referenced from the installed configuration in said water reservoir, and wherein said water reservoir comprises a weight support member adapted to support said plant pot support member and the weight thereon and includes a plurality openings adapted to allow water to pass through, and a corresponding plurality of screen members covering each opening and thereby resisting foreign material to pass through the openings, and wherein roots that have grown into the water reservoir from the plant pot are prevented from impeding with the function of the water level indicator, and wherein said lower end of said wick passes therein through the top of said weight support member, and wherein said plant pot support member is placed upon said water reservoir and when the supply of potted soil placed upon said plant pot support member, the said water reservoir becomes sealed, and thereby resists the transmission therein of dirt, dust, and insects.

6. The watering device of claim 1, wherein said fingers of said wick support member have attached thereupon a lattice structure adapted to increase and maximize the surface area of the wick strands within the potted soil and wherein said wick support member is formed from a flexible and durable material.

7. The watering device of claim 1, wherein said fingers of said wick support member have flared ends.

8. The watering device of claim 1, wherein said water flow control device is formed as a flat ring having a central opening wherein a predetermined number of said fibrous wick strands are passed therethrough and wherein a predetermined number of the strands do not pass therethrough, thereby limiting the amount of water capable of being passed from said water reservoir to the supply of potted soil by limiting the amount of the wick strands in contact with the water; and wherein the water flow control device is formed from material that is rigidly flexible and is water resistant.

9. The watering device of claim 1, wherein said water level indicator comprises a rigidly formed arm with an indicating end and a distal end that has a float member attached wherein said float member is adapted to float on top of the water within said water reservoir and wherein a fulcrum is attached to a bottom side of said plant pot support member to which said arm can pivotably attach, and said indicating end is adapted to extend upwardly through a hole in said pot support member in an amount proportional to the level of the water within said reservoir.

10. The watering device of claim 8, wherein said rigidly formed arm has a plurality of bends adapted to limit the height and width of the radial arc that is upwardly created by the motion of said indicating end as it rises and falls above said pot support member.

11. A pot for growing potted plants in soil comprising:
(a) an upper plant pot member adapted to hold soil and potted plants.
(b) a plant pot support member adapted to support said upper plant pot thereabove that rests upon an upper portion of a water reservoir therebelow.
(c) said water reservoir adapted to hold a supply of water;
(d) a watering device comprising a wick formed from a plurality of strands of fibrous material that is water resistant, rot resistant, and capable of capillary action adapted to deliver water from the lower end that is inserted into said water reservoir to the upper end inserted into said upper pot member, a wick support member comprising of a plurality of fingers capable of holding said wick within the soil in predetermined patterns, a water flow control device capable of limiting the amount of water received through said wick, a water level indicator capable of measuring the depth of water within said water reservoir at all times, wherein said wick is adapted to be inserted through said water flow control device and into said water reservoir such that a predetermined amount of water is capable of flowing through said wick.

12. The pot for growing potted plants of claim 11, wherein said water reservoir comprises a weight support adapted to support said plant pot support member and the weight thereon and includes a plurality openings adapted to allow water to pass through, and a corresponding plurality of screen members covering each opening and thereby resisting foreign material to pass through the openings and wherein roots that have grown into the water reservoir from the plant pot are prevented from impeding with the function of the water level indicator, and wherein said lower end of said wick passes therein through the top of said weight support member.

13. The pot for growing potted plants of claim 11, wherein when said plant pot support member is placed upon said water reservoir and when the supply of potted soil placed upon said plant pot support member, the said water reservoir becomes sealed, and thereby resists the transmission therein of dirt, dust, and insects.

14. The pot for growing potted plants of claim 11, wherein said plant pot support member is formed with a slight concave top surface as referenced from the installed configuration in said water reservoir, and wherein said water reservoir comprises a weight support member adapted to support said plant pot support member and the weight thereon and includes a plurality openings adapted to allow water to pass through, and a corresponding plurality of screen members covering each opening and thereby resisting foreign material to pass through the openings, and wherein roots that have grown into the water reservoir from the plant pot are prevented from impeding with the function of the water level indicator, and wherein said lower end of said wick passes therein through the top of said weight support member, and wherein said plant pot support member is placed upon said water reservoir and when the supply of potted soil placed upon said plant pot support member, the said water reservoir becomes sealed, and thereby resists the transmission therein of dirt, dust, and insects.

15. The pot for growing potted plants of claim 11, wherein said fingers of said wick support member have attached thereupon a lattice structure adapted to increase and maximize the surface area of the wick strands within the potted soil and wherein said wick support member is formed from a flexible and durable material.

16. The pot for growing potted plants of claim 11, wherein said fingers of said wick support member have flared ends.

17. The pot for growing potted plants of claim 11, wherein said water flow control device is formed as a flat ring having a central opening wherein a predetermined number of said fibrous wick strands are passed therethrough and wherein a predetermined number of the strands do not pass therethrough, thereby limiting the amount of water capable of being passed from said water reservoir to the supply of potted soil by limiting the amount of the wick strands in contact with the water; and
wherein the water flow control device is formed from material that is rigidly flexible and is water resistant.

18. The pot for growing potted plants of claim 11, wherein said water level indicator comprises a rigidly formed arm with an indicating end and a distal end that has a float member attached wherein said float member is adapted to float on top of the water within said water reservoir and wherein a fulcrum is attached to a bottom side of said plant pot support member to which said arm can pivotably attach, and said indicating end is adapted to extend upwardly through a hole in said pot support member in an amount proportional to the level of the water within said reservoir, and wherein said rigidly formed arm has a plurality of bends adapted to limit the height and width of the radial arc that is upwardly created by the motion of said indicating end as it rises and falls above said pot support member.

19. A method for adapting an existing drainage hole equipped plant pot filled with soil with an automatic watering device, the steps comprising:
(a) providing a wick and a wick support member with a plurality of wick support fingers, then attaching said wick to said wick support member, and then pinching the fingers into a predetermined insertion position with the terminating ends of the fingers touching;
(b) upwardly inserting said wick and said wick support member up into a bottom section of existing plant pot through its drainage hole;
(c) providing a water flow control device adapted to limit the amount of water received through said wick, then threading said wick through said water flow control device wherein a predetermined number of said fibrous wick strands are passed therethrough and wherein a predetermined number of the strands do not pass therethrough, thereby limiting the amount of water capable of being passed from said water reservoir to the supply of potted soil by limiting the amount of the wick strands in contact with the water;
(d) providing a water reservoir with a plant pot support member attached to an upper portion and a water level indicator adapted to measure the amount of water within the reservoir contained therein, filling the reservoir with water, then placing the distal end of the wick within the water reservoir and setting the existing plant pot upon said plant pot support member.
